(19) United States
(12) Patent Application Publication
(10) Pub. No.: US 2006/0059963 A1
(43) Pub. Date: Mar. 23, 2006

(54) Wireless access control system including wireless exit kit (''WEXK'') with panic bar

(75) Inventor: Fred J. Conforti, Lisle, IL (US)

Correspondence Address: MICHAEL BEST & FRIEDRICH, LLP, 100 E WISCONSIN AVENUE, MILWAUKEE, WI, 53202, US

(73) Assignee: Harrow Products LLC, Montvale, NJ (US)

(21) Appl. No.: 11/234,007

(22) Filed: Sep. 23, 2005

Related U.S. Application Data
(63) Continuation-in-part of application No. 11/039,010, filed on Jan. 20, 2005.
(60) Provisional application No. 60/537,922, filed on Jan. 20, 2004.
(60) Provisional application No. 60/613,050, filed on Sep. 25, 2004.

(51) Int. Cl. E05B 65/08

(52) U.S. Cl. 70/100; 340/5.73

(57) ABSTRACT

A wireless access system is provided that includes a wireless exit kit (“WEXK”) having a panic bar and a door position sensor. The WEXK is mounted on a door or other access point. The WEXK also includes a wireless transceiver for transmitting a signal from the access point to a panel interface module and eventually to an access control panel. The WEXK monitors the panic bar and door position sensor. The panic bar is user-actuatable and, when actuated, causes a request-to-exit signal to be transmitted to the transceiver. If the transceiver receives an indication from the door position sensor that the door is open and no request-to-exit signal has been received, then the transceiver generates an alarm. Conversely, if the transceiver has receivd a request-to-exit signal from the panic bar, no alarm is generated.

### RELATED APPLICATIONS

This application is a continuation in part of application Ser. No. 11/039,010, entitled “Wireless Access Control System With Energy-Saving Piezo-Electric Locking” filed on Jan. 20, 2005, which claims priority to application Ser. No. 10/261,933, entitled “RF Channel Linking Method and System” filed on Sep. 30, 2002; application Ser. No. 10/262,207, entitled “Energy Saving Motor-Driven Locking Subsystem” filed on Sep. 30, 2002; application Ser. No. 10/262,509 entitled “Cardholder Interface for an Access Control System” filed on Sep. 30, 2002; application Ser. No. 10/262,196, entitled “System Management Interface for Radio Frequency Access Control” filed on Sep. 30, 2002; application Ser. No. 10/262,194 entitled “Power Management for Locking System” filed on Sep. 30, 2002; application Ser. No. 10/262,507, entitled “General Access Control Features for a RF Access Control System” filed on Sep. 30, 2002; application Ser. No. 10/262,077, entitled “RF Wireless Access Control for Locking System” filed on Sep. 30, 2002; application Ser. No. 10/262,508, entitled “Maintenance/Trouble Signals for a RF Wireless Locking System” filed on Sep. 30, 2002; application Ser. No. 10/262,249, entitled “RF Dynamic Channel Switching Method” filed on Sep. 30, 2002; and U.S. Provisional Patent Application No. 60/537,922, entitled “Wireless Access Control System With Energy-Saving Piezo-Electric Locking” filed on Jan. 20, 2004. This application also claims the benefit of U.S. Provisional Application Ser. No. 60/613,050 filed on Sep. 25, 2004, the entire content of which is incorporated by reference herein.

### BACKGROUND

The invention generally relates to wireless access control system. More particularly, the invention relates to a wireless access control system including a door-mounted panic bar.

The present application presents improvements on various aspects of a wireless access system that is disclosed in greater detail in the following patent applications: application Ser. No. 11/039,010, entitled “Wireless Access Control System With Energy-Saving Piezo-Electric Locking” filed on Jan. 20, 2005; application Ser. No. 10/261,933, entitled “RF Channel Linking Method and System” filed on Sep. 30, 2002; application Ser. No. 10/262,207, entitled “Energy Saving Motor-Driven Locking Subsystem” filed on Sep. 30, 2002; application Ser. No. 10/262,509 entitled “Cardholder Interface for an Access Control System” filed on Sep. 30, 2002; application Ser. No. 10/262,196, entitled “System Management Interface for Radio Frequency Access Control” filed on Sep. 30, 2002; application Ser. No. 10/262,194 entitled “Power Management for Locking System” filed on Sep. 30, 2002; application Ser. No. 10/262,507, entitled “General Access Control Features for a RF Access Control System” filed on Sep. 30, 2002; application Ser. No. 10/262,077, entitled “RF Wireless Access Control for Locking System” filed on Sep. 30, 2002; and application Ser. No. 10/262,508, entitled “Maintenance/Trouble Signals for a RF Wireless Locking System” filed on Sep. 30, 2002; application Ser. No. 10/262,249, entitled “RF Dynamic Channel Switching Method” filed on Sep. 30, 2002.

Present day door locking systems typically include a lock on a first side of a door (typically the outside of the door) and a release bar, often called a panic bar, on the second side of a door (typically the inside of the door). The panic bar is typically triggered by a user seeking to exit from an installation. Often the panic bar is connected to an alarm system, such as a security system, so that engaging the panic bar will trigger the fire alarm.

In present systems, the panic bar must be physically wired to the security alarm system. Physically wiring the panic bar to the security alarm system is often undesirable, especially when retro-wiring buildings that have already been built. That is, running connecting wires from a door installation site to a centralized security alarm system in an already built installation requires a great deal of time, effort, and disturbance. For example, holes may need to be punched in walls, door installations may need to be altered, etc.

Such activity is in addition to the expense of the actual linear feet of connecting wire that must be installed. Such wire is typically not inexpensive due to compliance with building codes and reliability issues.

Consequently, a system and method providing for the functionality of a panic bar without the additional expense of wiring is desirable. Additionally, such a system may be especially desirable when retro-wiring an installation in order to avoid costly and time-consuming modifications and installation activity.

### SUMMARY

A wireless exit kit (“WEXK”) is provided that includes a panic bar, a wireless transceiver, and a door position switch. The WEXK is preferably mounted in a door or other access point and is in wireless communication with a panel interface module (“PIM”). The PIM in turn communicates with and is preferably wired to an access control panel (“ACP”). The panic bar is user-actuatable and, when actuated, causes a request-to-exit signal to be transmitted from the transceiver to the PIM. The request-to-exit signal then travels to the ACP. Additionally, the door position switch generates a door position signal that identifies when the door changes state, for example when the door opens. The door position signal is also transmitted by the wireless transceiver to the PIM and then to the ACP. The ACP detects the door position signal and the request-to-exit signal. If the door position signal indicates a change in the position of the door from closed to open and no request-to-exit signal has been received, then the ACP initiates a security access alarm. Conversely, if a request-to-exit signal has been received by the ACP, then the ACP does not initiate an alarm upon the receipt of the door position signal.

In one form, the invention provides a wireless access system that includes a door, a door position switch, a user-actuable device, and an access control panel. The door position switch is mounted on the door such that the door position switch provides a door position indicator to indicate whether the door is open or closed. The user-actuatable device is mounted near the door. The user actuable device is configured to provide a request-to-exit signal when the user-actuatable device is actuated. The access control panel (“ACP”) can receive the door position indicator and the request-to-exit signal, and generate an alarm signal when the door position indicator indicates the door is open and no request-to-exit signal has been received.

In another form, the invention provides a method for access control. The method includes generating a door position signal at a door. The door position signal provides an indication of when the door is opened. The method also includes providing the ability to generate a request-to-exit signal at said door in response to a user-actuatable device, and initiating an alarm when said door position signal is received at an access control panel and no request-to-exit signal is received at said access control panel.

In yet another form, the invention provides an exit system that includes a door, an access device, a position sensor, and a control device. The door has a door position including a closed position in which the door is substantially closed, and an open position in which the door is substantially opened. The access device is mounted on the door, and configured to engage the door in the closed position, to disengage the door from the closed position, and to wirelessly transmit a disengaged signal after the door is disengaged from the closed position. The position sensor monitors the door position, and wirelessly transmits a second signal after the door is in the open position. The control device is spaced apart from the door, and wirelessly monitors and receives the disengaged and second signals, to determine from the disengaged and second signals if the door is securely disengaged.

In yet another form, the invention provides a method of monitoring an exit door that is movable moveable between a closed position substantially closing the exit door and an open position substantially opening the exit door. The exit door also has an access device mounted thereon. The method includes determining a door position, wirelessly transmitting the door position after the exit door is in the open position, wirelessly transmitting a disengaged signal after the exit door is disengaged from the closed position, and determining from the disengaged and second signals if the door is securely disengaged.

Other aspects of the invention will become apparent by consideration of the detailed description and accompanying drawings.

### BRIEF DESCRIPTION OF THE DRAWINGS

FIG. 1 is a wireless access system in a block diagram format.

FIG. 2 depicts the wireless access system of FIG. 1 mounted on an exit door in a closed position.

FIG. 3 depicts the wireless access system of FIG. 1 mounted on the exit door in an open position.

FIG. 4 is a flow chart illustrating an exemplary operation of the wireless access system of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” and “coupled” and variations thereof are used broadly and encompass both direct and indirect mountings, connections, supports, and couplings. Further, “connected” and “coupled” are not restricted to physical or mechanical connections or couplings.

As should also be apparent to one of ordinary skill in the art, the systems shown in the figures are models of what actual systems might be like. As noted, many of the modules and logical structures described are capable of being implemented in software executed by a microprocessor or a similar device or of being implemented in hardware using a variety of components including, for example, application specific integrated circuits (“ASICs”). Terms like “controller” may include or refer to both hardware and/or software. Furthermore, throughout the specification capitalized terms are used. Such terms are used to conform to common practices and to help correlate the description with the coding examples and drawings. However, no specific meaning is implied or should be inferred simply due to the use of capitalization. Thus, the claims should not be limited to the specific examples or terminology or to any specific hardware or software implementation or combination of software or hardware.

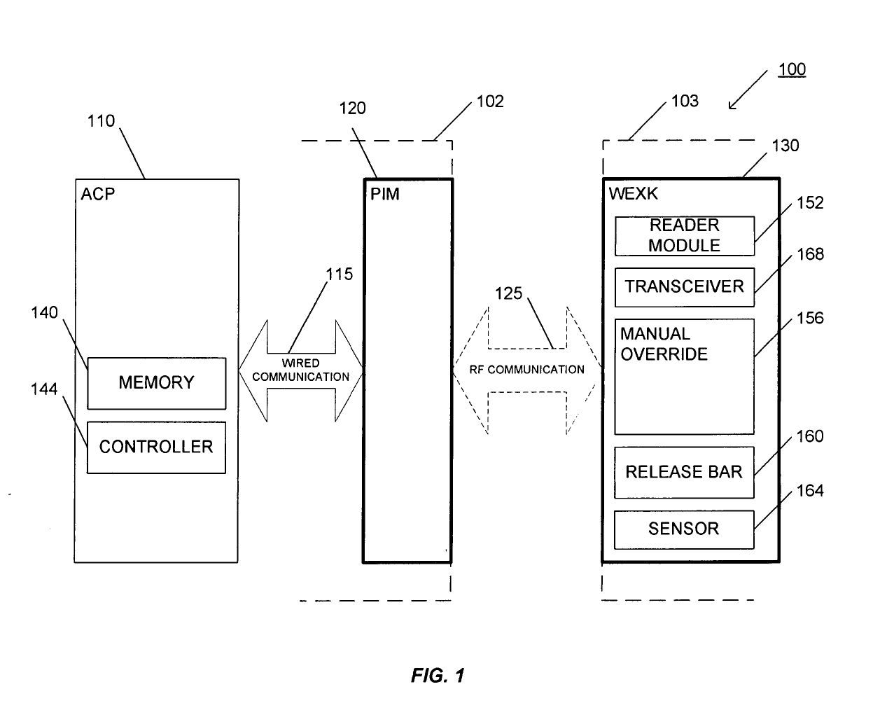

FIG. 1 illustrates a block diagram of the components of a wireless access system 100 according to a preferred embodiment of the present invention. The wireless access system 100 includes several components installed at one of two generalized locations, an access control panel location 102 and an access point location 103. The access control panel location 102 includes an access control panel (“ACP”) 110 and a panel interface module (“PIM”) 120. The access point location 103 includes a wireless exit kit (“WEXK”) 130. The access control panel 110 communicates with the PIM 120 through a bi-directional wired communication link 115. The PIM 120 communicates with the WEXK 130 through a bi-directional radio-frequency (“RF”) or wireless communication link 125. The access point location 103 is preferably a door or a portal, but may be a container, secure location, or a device of some kind, for example. In operation, an access signal is read at the access point location 103. The access signal may be a signal from an access card, for example, a magnetic stripe or Wiegand access card. Alternatively, the access signal may be a biometric or a numeric sequence or some other access signal. The access signal is relayed from the access point 103 using the WEXK 130. The access control panel location 102 is generally spaced apart from the access point location 103. In this way, the WEXK 130 can be retrofitted in existing installations without posting location or installation restrictions on the ACP 110 and the PIM 120.

Once the WEXK 130 receives the access signal from the access point location 103, the WEXK 130 wirelessly broadcasts or transmits the access signal to the PIM 120 over the wireless RF communication link 125. The PIM 120 receives the access signal and relays the access signal to the ACP 110 over the wired communication link 115.

The ACP 110 includes a database of authorized access signals. In the embodiment shown, the database is stored in a memory 140. If the access signal received from the PIM 120 is determined at a controller 144 of the ACP 110 to be a signal corresponding to an authorized user, a confirmation signal is transmitted from the transceiver 148 of the ACP 110 to the PIM 120 and then to the WEXK 130. The WEXK 130 then unlocks to provide access to the door, for example.

In the embodiment shown, the WEXK 130 also includes other components such as a reader module 152 that reads the access card as described. The WEXK 130 also includes a manual override module 156 that can be used to manually override any locking instructions received or stored at the WEXK 130. The WEXK 130 also includes an access device 160 to allow someone to access to the door, for example. A sensor 164 is positioned or mounted near the WEXK 130 such that movement of the door, for example, can be monitored. signals generated by or received at the WEXK 130 are transmitted or received at the transceiver module 168. In this way, the signals can be collected or received at the transceiver module 168, and be transmitted to other nearby receiver module, transceiver module, or interfaces such as the PIM 120.

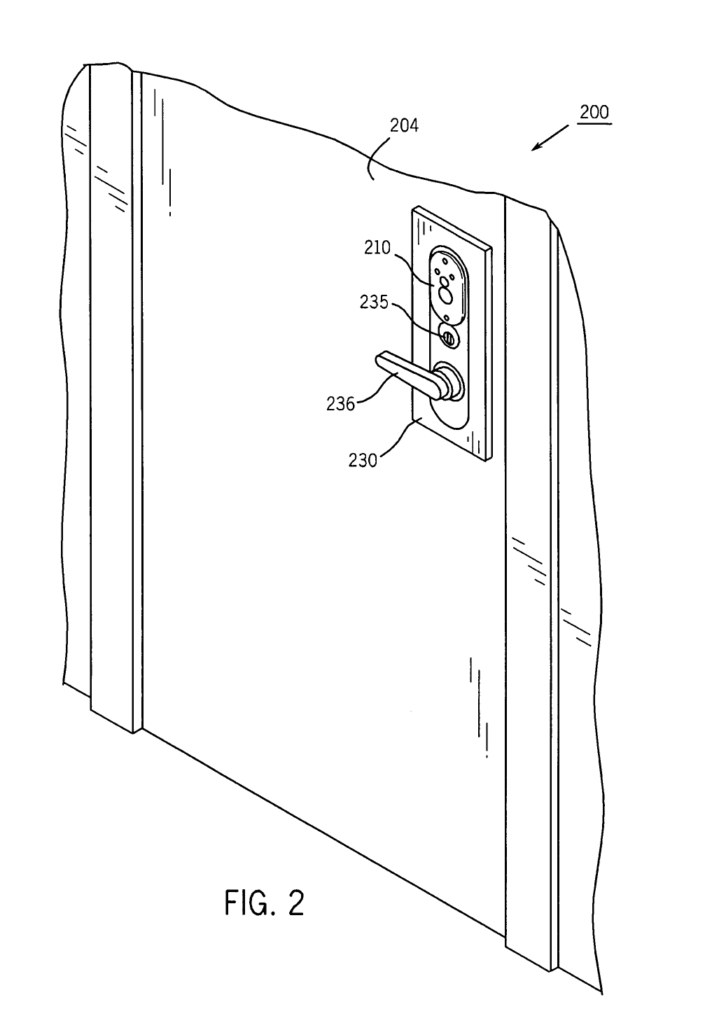

FIG. 2 illustrates the WEXK 130 of the wireless access control system 100 of FIG. 1 implemented in an exit system 200 that includes a door 204. Particularly, FIG. 2 shows an outside view of the door 204 that is in a closed position. The WEXK 130 includes a reader module 210 (152 of FIG. 1) positioned on a face-plate 230 mounted on the door 204. In some embodiments, the reader module 210 includes a plurality of light-emitting-diodes (“LED's”) to indicate status of the WEXK 130 or other desired functions, card sensors to read the access card, proximity sensors to determine a distance between the door 204 and an object (not shown). Generally, the face-plate 230 also includes a key override 235 and a lever 236.

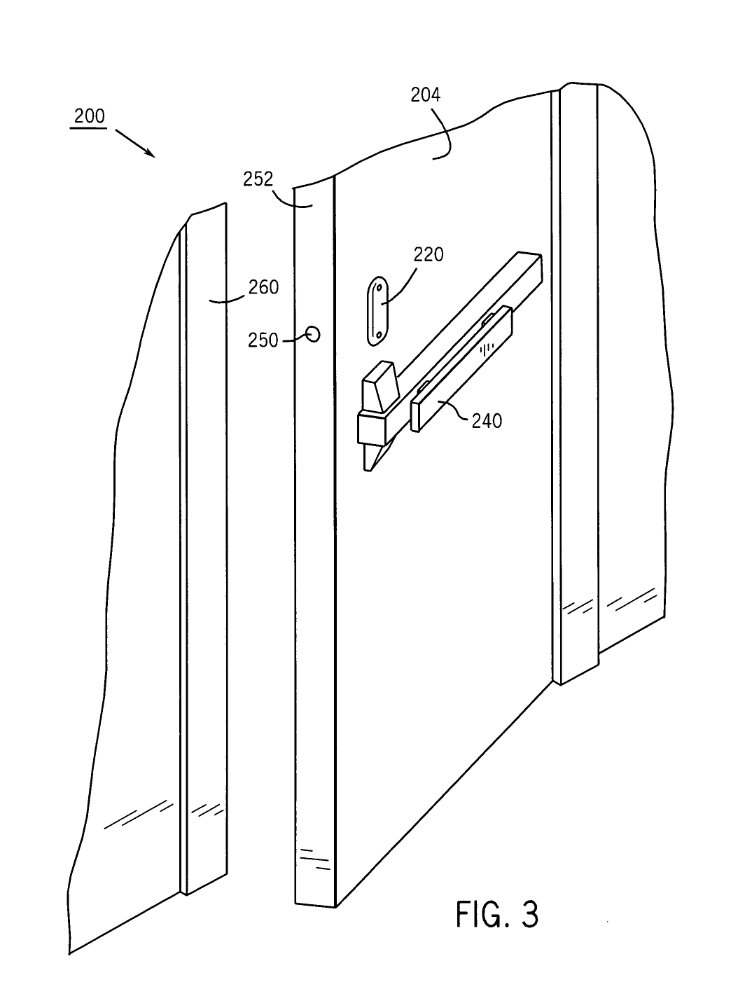

FIG. 3 illustrates the door 204 of the wireless access control system 100 of FIG. 2 in an open position. Particularly, FIG. 3 also shows an inside or a protected side of the door 204 that is in an open position. The WEXK 130 includes a transceiver module 220, a door position switch or sensor 250 mounted on a side of the door 204, and a panic bar 240. In some embodiments, the door position switch 250 is mounted along a first side 252 of the door 204 so that the door position switch 250 is able to detect when the door 204 is in an opened position. In other embodiments, the door position switch 250 is mounted on other sides of the door 204.

The door position switch 250, panic bar 240, reader module 210, and trim faceplate 230 are all connected to and in communication with the transceiver module 220, as further described below. In some embodiments, the door position switch 250 is a magnetic sensor that is affixed to the door 204 and operates in conjunction with a ferromagnetic element that is positioned in a door jam 260 so that the magnetic sensor is in close proximity to the ferromagnetic element when the door 204 is closed, or engaged with the door jam 260. Preferably, the door position switch 250 generates a signal when a state of the magnetic sensor changes. For example, the door position switch 250 generates after the door is moved from an open to a closed position. Alternatively, the door position switch 250 may generate a signal indicative of a position of the door. For example, the door position switch 250 only generates a signal when the door is closed, or when the door is opened.

Additionally, in some embodiments, the trim faceplate 230 contains a lock that is controllable using an electronic signal from the transceiver 220. Specifically, the transceiver may preferably activate a motor in the trim faceplate 230 in order to engage the lock.

The operation of the reader module 210, faceplate 230, and transceiver module 220 proceed generally as described in greater detail in the above-identified cases to which the present case claims priority. For example, a user attempting to gain access may present an identifier to the reader module 210. The identifier may be a token such as an optical, magnetic, or proximity card, for example, or may be a biometric such as a fingerprint. The reader module 210 receives the identifier and passes the identifier to the transceiver module 220. The transceiver module 220 then wirelessly transmits data representing the identifier to the PIM 120 (of FIG. 1) which then relays the data representing the identifier to the ACP 110, as described above.

The ACP 110 then makes a determination to grant or deny access at the controller 144. The controller 144 (of FIG. 1) subsequently relays the determination or instructions to the PIM 120. In turn, the PIM 120 wirelessly relays the determination and instructions to the transceiver module 220. The transceiver module 220 then receives the determination or instructions, and unlocks the door 204 if the controller 148 determines that access should be granted. Conversely, if the controller 148 determines to deny access, the transceiver module 220 does not unlock the door. When the transceiver module 220 receives the instruction to unlock the door 204, the transceiver module 220 sends an unlock command to a lock in the trim faceplate 230 instructing the lock to disengage.

In addition to the above operation, the WEXK 200 adds the panic bar 240. The panic bar 240 is similar to commonly used commercially available panic bars. However, the panic bar 240 of the present embodiment is able to send signals to the transceiver module 220. Specifically, the panic bar 240 communicates with the transceiver module 220, preferably via a connecting wire.

The panic bar 240 operates in conjunction with the door position switch 250 to cause an access control alarm to be initiated when unauthorized access is obtained through the door 204. More specifically, when the panic bar 240 is pressed, the panic bar 240 generates a request-to-exit signal (“RTES”), which may also be called a panic bar signal. The request-to-exit signal is received by the transceiver 220 and relayed to the ACP 110 through the PIM 120.

The transceiver 220 continuously monitors the door position switch 250. When the door is opened, the door position switch 250 generates a door open signal (“DOS”) which is sent from the transceiver 220 to the ACP 110 through the PIM 120. The transceiver 220 is also continuously monitoring for other signals such as the request-to-exit signal generated by the panic bar 240, or an input to the reader module 210, as described above.

The ACP 110 receives both the request-to-exit signal and the door open signal, and then makes a determination of whether there has been a security breach. That is, if the ACP 110 receives a door open signal from the door position switch 250, but the ACP 110 has not received a request-to-exit signal from the panic bar 240, the ACP 110 generates a security breached signal or an access control alarm. In other words, if the door 204 is opening, but the panic bar 240 has not been depressed, the ACP 110 determines that security has been breached and generates an alarm.

On the other hand, if the ACP 110 has processed an access request through the reader module 210 and has caused the door to be opened, no security alarm is generated. That is, if the ACP 110 has purposely unlocked the door, the ACP 110 does not generate an alarm when the door is opened, even if no request-to-enter signal is received from the panic bar 240.

In some embodiments, when the key override 235 in the trim faceplate 230 is used, the ACP 110 still generates an alarm unless a successful access request has been received by the reader module 210. In other embodiments, the ACP 110 may be configured not to generate an alarm if the key override 235 in the trim faceplate 230 is used. That is, once the transceiver 220 has detected that the key override 235 is used, the alarm remains inactive even though a request-to-exit signal from the panic bar 240 has not been received.

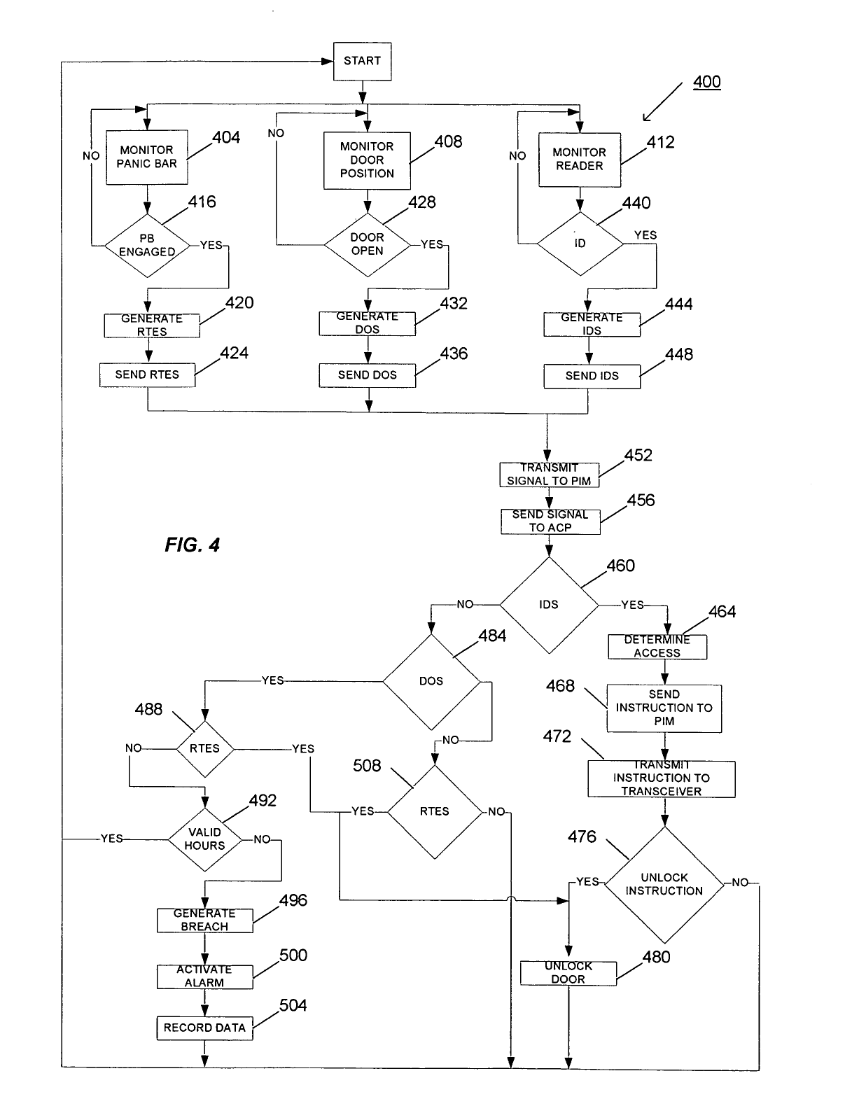

FIG. 4 includes a flow chart that further illustrates an exemplary access process 400 that occur in some embodiments including processes that may be carried out by software, firmware, or hardware. As noted, the panic bar 240, the door 204, and the card reader 210 are monitored at blocks 404, 408, 412, respectively. If the panic bar 240 has been actuated, engaged, or pressed, as determined at block 416, a request-to-exit signal (“RTES”) is generated at block 420. The RTES is sent to the transceiver 220 at block 424 for wireless transmission. Meanwhile, the door position switch 250 continues to monitor the door position (block 408). When the door 204 is opened, as determined at block 428, a door open signal (“DOS”) is generated at block 432. The DOS is sent to the transceiver 220 at block 436 for wireless transmission. Similarly, once the reader module 210 has read an identification as determined at block 440, an identification signal (“IDS”) is generated at block 444. The IDS is subsequently sent to the transceiver at block 448 for wireless transmission to the PIM 120 at block 452. Once the PIM 120 has received a signal, which can be a combination of the RTES, DOS, and IDS, the signal is in turn sent to the ACP 110 for processing at block 456.

In the embodiment shown, when the IDS is present in the signal as determined at block 460, the ACP 110 determines if the IDS is valid for access at block 464. Once a decision is made, the ACP 110 sends the decision along with its instructions to the PIM 120 at block 468 for subsequent wireless transmission back to the transceiver 220 at block 472. If the decision is to grant access or to unlock the door 204 as determined at block 476, the door 204 is unlocked at block 480. Otherwise, if the decision is to deny access as determined at block 476, the door 204 remains unlocked, and the process 400 repeats.

However, if no identification is present in the signal as determined at block 460, the process 400 continues to monitor if the signal includes a DOS at block 484. If a DOS is present, the process 400 continues to determine if an RTES is present at block 488. In the embodiment shown, if the process 400 determines that an RTES is absent, the process 400 optionally checks to determine if the DOS is sent during valid business hours at block 492. If the DOS is sent during valid business hours, the process 400 repeats. Otherwise, if the DOS is not sent during valid business hours, a security breached signal is generated at the ACP 110 at block 496, the alarm is activated at block 500, and data relating to the breach is recorded at block 504.

If the signal does not include a DOS as determined at block 484, the process 400 determines if a RTES is present such as in an override situation sent from the ACP 110 at block 508. If there is no RTES as determined at block 508, the process 400 repeats. Otherwise, the door 204 is unlocked at block 480 when the signal includes an RTES.

Reciting the operation of the panic bar 240 another way, when the panic bar 240 is engaged, the panic bar 240 mechanically opens the door to provide immediate egress from the installation, for example, in case of an emergency. When the panic bar 240 is depressed, the panic bar 240 also generates an electrical request-to-exit signal that travels from the panic bar 240 to the transceiver 220 using a wired connection.

Ignoring for the moment the operation of the reader module 210 and trim faceplate 230, the transceiver 220 waits to receive signals from the door position switch 250 and the panic bar 240. Any signals received from the door position switch 250 or the panic bar 240 by the transceiver are then wirelessly transmitted to the PIM 120. This signals received by the PIM 120 are then preferably transmitted to the ACP 110 using a wired connection.

If the ACP 110 receives a door open signal from the door position switch 250 and no request-to-exit signal has been received from the panic bar 240, then the ACP 110 initiates an access control alarm. Conversely, if the ACP 110 receives a door open signal from the door position switch 250 and a request-to-exit signal has already been received from the panic bar 240, then the ACP 110 does not initiate an access control alarm.

Once the ACP 110 generates an access control alarm, an indication is preferably displayed of the location of the origin of the panic bar/alarm signal. For example, the ACP 110 may display a schematic map of the installation. The location of the access point at which the present alarm signal originated may then be displayed on the schematic map of the installation.

Alternatively, when the ACP 110 receives the alarm signal, the ACP 110 may initiate an audible alarm indicating a breach of security, or the ACP 110 may generate an inaudible alarm, such as are typically used for alerting law enforcement.

Additionally, the ACP 110 preferably records data with regard to the alarm such as the location of the alarm and the time of the alarm. Additionally, the length of time that the door remained open during the alarm may also be determined by the ACP 110 and recorded. That is, the ACP 110 may record the length of time between receipt of the door open signal and receipt of the “door closed” signal.

Alternatively, the ACP 110 may be configured to differentiate its response based on a variable such as the time of day, for example. For example, it may be desirable to leave the door unlocked and accessible from both sides during business hours, but then not permit access from the outside after business hours. Consequently, the ACP 110 may be configured not to initiate an alarm signal during business hours if a door open signal is received from the door position switch 250 and no request-to-exit signal has been received from the panic bar 240 (and no other signal, such as from the key override 235 or reader module 210 has been received). Conversely, after business hours, the ACP 110 may generate an alarm if a door open signal is received from the door position switch and no request-to-exit signal has been received from the panic bar 240 (and no other signal, such as from the key override 235 or reader module 210 has been received).

Additionally, the WEXK 130 needs not be implemented in a network solely comprising a plurality of WEXK's. For example, other types of access systems, as described in the patent applications incorporated by reference above, may also be included in an access control network including WEXK's.

Also, although a panic bar is illustrated in the embodiment of FIG. 3, the origination of the panic signal is not limited to a panic bar. For example, a panic button or switch may be included in the WEXK 130. instead of or in addition to the panic bar. Further, any user-actuatable device that produces a request-to-exit signal may be used. Also, the panic bar 240 may be any commercially available type of panic bar such as Ingersoll-Rand Company's Von Duprin 98 and 99 series.

In an alternate embodiment, the transceiver 220 may be equipped to make a determination of whether a request-to-exit signal has been received in conjunction with a door open signal. For example, the transceiver 220 may have a default mode of operation for use in case wireless communication with the PIM 120 is blocked. In the default mode, the transceiver 220 may sense whether the door 204 has been opened without a request-to-exit signal and, if so, to generate a local alarm in communication with the transceiver 220. If communication with the PIM 120 is reestablished, the transceiver 220 will communicate the alarm condition to the PIM 120 to be relayed to the ACP 110.

While particular elements, embodiments and applications of the present invention have been shown and described, it is understood that the invention is not limited thereto since modifications may be made by those skilled in the art, particularly in light of the foregoing teaching. It is therefore contemplated by the appended claims to cover such modifications and incorporate those features which come within the spirit and scope of the invention.

Various features and advantages of the invention are set forth in the following claims.

What is claimed is:

1. A wireless access system including:
a door position switch mounted on a door, said door position switch providing a door position indicator indicating whether said door is open or closed;
a user-actuatable device mounted near said door, said user actuable device providing a request-to-exit signal when said user-actuatable device is actuated; and
an access control panel (“ACP”), said access control panel receiving said door position indicator and said request-to-exit signal and generating an alarm signal when said door position indicator indicates said door is open and no request-to-exit signal has been received.

2. The system of claim 1 wherein said ACP does not generate an alarm when said door position indicator indicates said door is open and a request-to-exit signal has been received.

3. The system of claim 1 wherein said request-to-exit signal and said door position indicator are received by a transceiver and relayed to said ACP through a panel interface module (“PIM”).

4. The system of claim 1 wherein said user-actuatable device is a panic bar.

5. The system of claim 1 wherein said user-actuatable device is a request-to-exit button.

6. The system of claim 1 wherein said access control panel provides an indication of the location of the door originating said door position indicator.

7. A method for access control including:
generating a door position signal at a door, said door position signal providing an indication of when said door is opened;
providing the ability to generate a request-to-exit signal at said door in response to a user-actuatable device; and
initiating an alarm when said door position signal is received at an access control panel and no request-to-exit signal is received at said access control panel.

8. The method of claim 7 further including not initiating an alarm when both said door position signal and a request-to-exit signal are received at said access control panel.

9. An exit system comprising:
a door having a door position including a closed position in which the door is substantially closed, and an open position in which the door is substantially opened;
an access device mounted on the door, and configured to engage the door in the closed position, to disengage the door from the closed position, and to wirelessly transmit a disengaged signal after the door is disengaged from the closed position;
a position sensor configured to monitor the door position, and to wirelessly transmit a second signal after the door is in the open position; and
a control device being spaced apart from the door, and configured to wirelessly monitor and receive the disengaged and second signals, to determine from the disengaged and second signals if the door is securely disengaged.

10. The system of claim 9, further comprising an alarm coupled to the control device, and configured to set off after the door is insecurely disengaged.

11. The system of claim 9, wherein the control device comprises a transceiver configured to receive the disengaged and second signals, and a controller coupled to the transceiver to receive and process the disengaged and second signals.

12. The system of claim 9, wherein the door is securely disengaged when the disengaged and second signals are present, and the door is insecurely disengaged when only the second signal is present.

13. The system of claim 9, wherein the position sensor is mounted on the door.

14. The system of claim 9, wherein the access device comprises at least one of a transceiver configured to wirelessly transmit the disengaged and second signals, and a release bar configured to disengage the door from the closed position.

15. A method of monitoring an exit door movable moveable between a closed position substantially closing the exit door and an open position substantially opening the exit door, the exit door having an access device mounted thereon, the method comprising:
determining a door position;
wirelessly transmitting the door position after the exit door is in the open position;
wirelessly transmitting a disengaged signal after the exit door is disengaged from the closed position; and
determining from the disengaged and second signals if the door is securely disengaged.

16. The method of claim 15, further comprising setting off an alarm after the door is insecurely disengaged.

17. The method of claim 15, further comprising:
wirelessly receiving the disengaged and second signals;
indicating the door is securely disengaged when the disengaged and second signals are present; and
indicating the door is insecurely disengaged when only the second signal is present.

18. The method of claim 15, wherein determining the door position further comprises sensing the door position at the door.

19. The method of claim 15, further comprising:
actuating a release bar; and
disengaging the exit door from the closed position after the release bar has been actuated.

20. The method of claim 15, further comprising generating the disengaged signal after the exit door is disengaged from the closed position.
